(19) United States
(12) Patent Application Publication
(10) Pub. No.: US 2023/0041428 A1
(43) Pub. Date: Feb. 9, 2023

(54) SYSTEM AND METHOD OF PHASED ARRAY ULTRASONIC INSPECTION OF TURBINE BLADES

(71) Applicants: Siemens Energy, Inc., Orlando, FL (US); Siemens Energy Global GmbH & Co. KG, Müchen (DE)

(72) Inventors: El Mahjoub Rasselkorde, Murrysville, PA (US); Stefan Obermayr, Duisburg (DE); Michael Clossen-von Lanken Schulz, Issum (DE); Luca Julian Lersch, Mülheim a.d. Ruhr (DE); Larry Himes, Greensburg, PA (US)

(21) Appl. No.: 17/395,025

(22) Filed: Aug. 5, 2021

(51) Int. Cl. F01D 21/00; G01N 29/26; G01N 29/22; G01N 29/04; G01B 21/22

(52) U.S. Cl. CPC F01D 21/003; G01N 29/262; G01N 29/225; G01N 29/043; G01B 21/22; F01D 5/30

(57) ABSTRACT

A nondestructive method for a volumetric examination of a blade root of a turbine blade while the turbine blade is installed in a turbine shaft of a steam turbine includes attaching a bracket to the turbine blade, the bracket conforming to the geometry of the turbine blade, positioning an ultrasonic phased array probe within a slot formed in the bracket to enable the probe to translate along the geometry of the turbine blade to a desired position for generation of a scan of a portion of the blade root, generating a scan of the desired position by directing ultrasonic waves via the ultrasonic phased array probe, and capturing reflected ultrasonic waves by a receiver to generate the scan and comparing the scan to a reference scan of the blade root to determine defects within the blade root.

### BACKGROUND

Due to high cycle fatigue stress and/or stress corrosion environment, defects such as cracks can occur in steam turbine rotor first and second row blade roots. The blade root is inserted into the turbine circumferential blade rows located closest to the end of the turbine shaft. Under operation of the steam turbine, blade crack growth in the blade root area can lead to failure of the blade and other associated components.

A current examination method for the steam turbine rotor blades requires removal of the rotor from the unit, removal of the locking plates that hold the blades in place, and then removal of a large number of blades from the turbine rotor. The inspection of the blades is done visually and/or utilizing fluorescent magnetic particle inspection. These methods are only capable of detecting flaws located at the surface or near the surface of the blade root.

Consequently, a non-destructive examination (NDE) method and system for inspecting steam turbine blades that can detect both surface defects as well as defects within the volume of the blade without disassembly of the rotor and the blades is desired.

### BRIEF SUMMARY

A system for a volumetric examination of a blade root of a turbine blade includes an ultrasonic phased array probe, a bracket defining a slot, an ultrasonic signal source, and a receiver connected to the probe. The probe is positioned within the slot to guide the probe to a desired position for generation of a scan of a portion of the blade root. The bracket is carried by and conforms to the geometry of the turbine blade and includes a first slot on a suction side and a second slot on a pressure side, the probe positionable within the first slot or the second slot to direct a wave in a direction to allow for scanning a position on a hook serration of the blade root. The ultrasonic signal source is connected to the probe via a line that provides an ultrasonic pulse signal. The receiver is connected to the probe via the line for receiving reflected ultrasonic pulse signals. A scan is generated by the system from the reflected ultrasonic pulse signals. The hook serration includes all the hook serrations of the blade root. The examination includes a scan of at least one of the pressure side of the blade root, the suction side of the blade root, and all the hook serrations of the blade root.

A nondestructive method for a volumetric examination of a blade root of a turbine blade while the turbine blade is installed in a turbine shaft of a steam turbine includes attaching a bracket to the turbine blade, the bracket conforming to the geometry of the turbine blade, positioning an ultrasonic phased array probe within a slot formed in the bracket to enable the probe to translate along the geometry of the turbine blade to a desired position for generation of a scan of a portion of the blade root, generating a scan of the desired position by directing ultrasonic waves via the ultrasonic phased array probe, and capturing reflected ultrasonic waves by a receiver to generate the scan and comparing the scan to a reference scan of the blade root to determine defects within the blade root. Generating the scan further includes generating a center scan by directing waves from the probe to positions on a hook serration of the blade root so that the scan includes a center portion of the blade root including each of all of the hook serrations of the blade root and generating an end scan by directing waves from the probe to positions on a hook serration of the blade root so that the end scan includes an end portion of the blade root including each of all of the hook serrations of the blade root.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a sectional view through a steam turbine.

FIG. 2 illustrates a perspective view of a turbine blade.

FIG. 3 illustrates a perspective view of a turbine blade with an attached ultrasonic phased array system.

FIG. 4 illustrates a perspective view of a portion of a turbine blade with a bracket attached.

FIG. 5 illustrates a perspective view of a convex bracket having a plurality of holes.

FIG. 6 illustrates a perspective view of a portion of the bracket including an encoder.

FIG. 7 illustrates a perspective view of a bracket with a probe mounted within a sled mechanism.

FIG. 8 illustrates a perspective view of an insert for mounting an ultrasonic probe.

FIG. 9 illustrates a perspective view of a sled for mounting an ultrasonic probe.

FIG. 10 is a flowchart summarizing a nondestructive method of volumetric examination of a turbine blade.

FIG. 11 illustrates a perspective view an installed convex bracket on a turbine blade next to an adjacent turbine blade.

### DETAILED DESCRIPTION

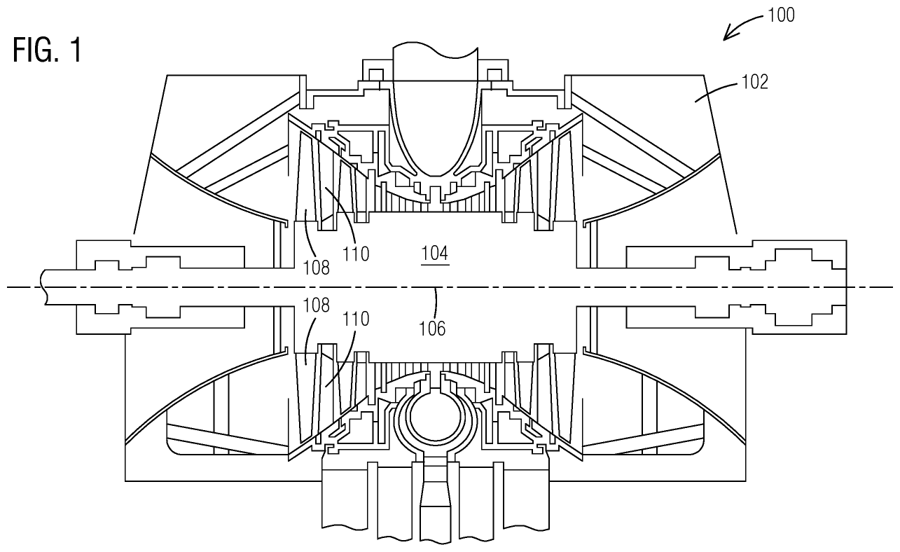

FIG. 1 shows a section through a steam turbine 100. The steam turbine 100 includes an outer casing 102 and an inner casing. A turbine shaft 104 is supported rotatably about a longitudinal axis 106 of rotation. On the turbine shaft 104 surface a plurality of turbine blades 108 are arranged. The blade root of each turbine blade 108 is inserted into turbine circumferential rows located closest to the end of the turbine shaft 104. In the inner casing, a plurality of guide vanes 110 are arranged. In operation, steam flows into a section of the steam turbine 100 where its expansion turns the turbine blades 108 on the turbine shaft 104 driving a rotor on a generator (not shown) to produce electricity.

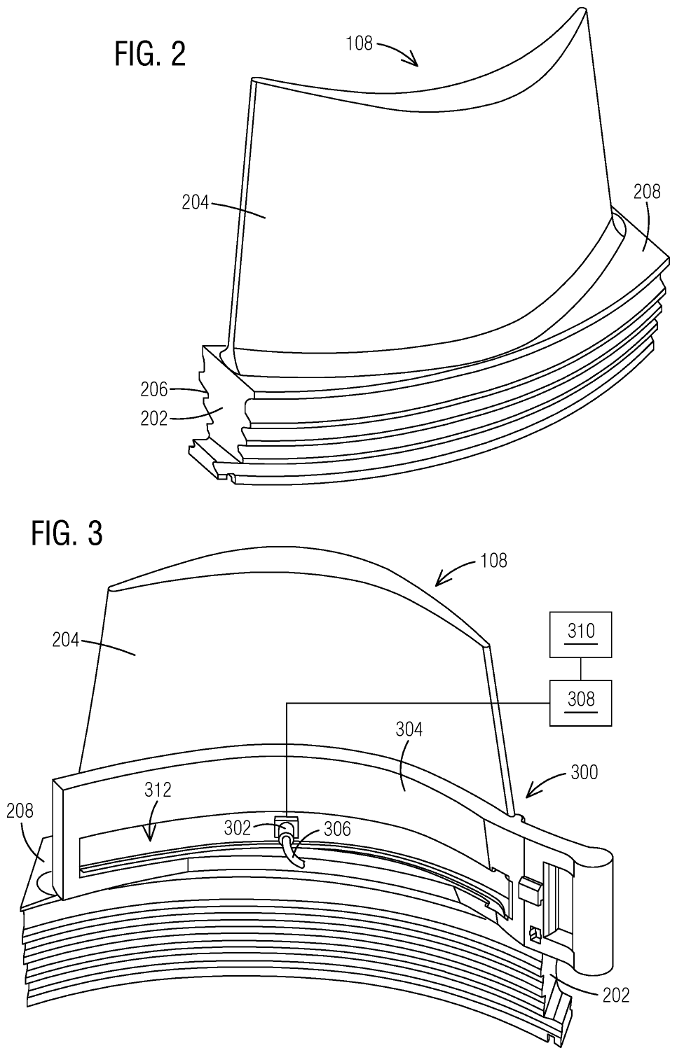

FIG. 2 shows a perspective view of a turbine blade 108. The turbine blade 108 includes a blade root 202 and an airfoil 204 extending from a platform 208. The blade root 202 shown is constructed in a fir tree style which includes a plurality of hook serrations 206. The blade root 202 may include 3-4 hook serrations 206. The turbine blade 108 shown in FIG. 2 shows a fir tree style blade root 202 with three hook serrations 206. When the steam turbine 100 is in operation, high centrifugal forces occur which can lead to defects in the form of cracks in the blade roots 202. Crack growth can lead to failure of the turbine blade 108 and other associated components.

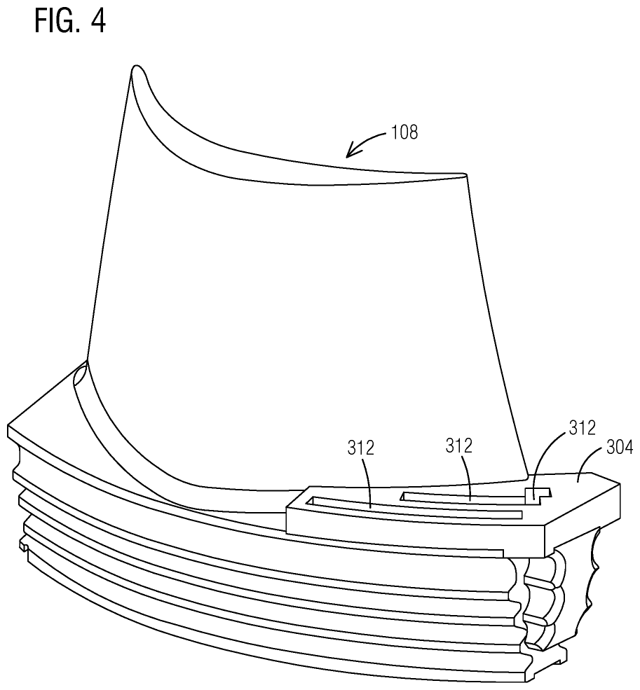

FIG. 3 shows a perspective view of a turbine blade 108 with an attached ultrasonic phased array inspection system 300. The attached ultrasonic phased array inspection system 300 includes a bracket 304 defining a slot 312. The bracket 304 conforms to the geometry of the turbine blade 108. FIG. 3 illustrates a concave bracket that conforms to the geometry of the concave side, or pressure side, of the airfoil 204. A bottom portion of the bracket 304 rests on the platform 208. The bracket 304 may also be a convex bracket that conforms to the geometry of the convex side, or suction side, of the airfoil 204. In further configurations, the bracket 304 may be an inlet bracket that conforms to the geometry of the inlet side of the airfoil 204, or an outlet bracket that conforms to the geometry of the outlet side of the airfoil 204. FIG. 4, for example, illustrates an inlet bracket 304 defining three slots 312. In an embodiment, the bracket 304 is produced utilizing an additive manufacturing process and comprises a thermoplastic material.

Referring back to FIG. 3, the ultrasonic phased array inspection system 300 also includes an ultrasonic probe 302, a line 306, a source 308, and a receiver 310. The ultrasonic probe 302 fits within the slot 312 in order to be positioned at a desired location for scanning of the blade root 202. The ultrasonic probe 302 is connected via the line 306 to the ultrasonic signal source 308 and the receiver 310. The ultrasonic signal source 308 generates a pulsed signal making the ultrasonic probe 302 vibrate. The vibration generates ultrasonic waves within the turbine blade 108. The ultrasonic probe 302 rests as close as possible to the turbine blade surface so that the transmission of the ultrasonic waves is as free from interference as possible. In an embodiment, the ultrasonic probe 302 comprises an ultrasonic phased array probe which allows ultrasonic probe 302 to generate the ultrasonic waves through the material of the turbine blade 108 at a fixed angle to the surface of the turbine blade 108 so that a volumetric examination of the turbine blade 108 may be performed. The ultrasonic waves are reflected back from defects and the boundary of the turbine blade 108. The returned ultrasonic waves also vibrate the ultrasonic probe 302. The receiver 310 receives the vibrations from the ultrasonic probe 302 and converts the vibrations to signals. From these signals, the receiver 310 generates a scan of the turbine blade 108. Two types of ultrasonic probes 302 may be utilized for the purpose of generating ultrasonic waves, a first probe to generate shear wave scans and a second probe to generate compression wave scans.

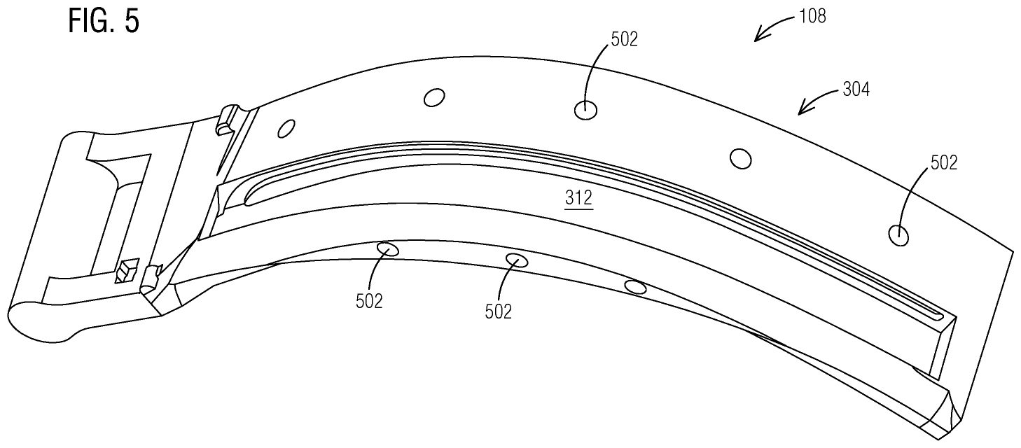

In an embodiment, the bracket 304 defines at least one hole 502 which accommodates a magnet for attachment to the turbine airfoil 204. FIG. 5 illustrates a convex bracket 304 defining a plurality of holes 502. As the turbine blade 108 comprises a magnetic metallic alloy, the magnet is sufficient to hold the convex and/or concave bracket 304 in place on the suction/pressure side, respectfully, of the airfoil 204. Alternately, the inlet bracket 304 and the outlet bracket 304 rest on the platform 208 which is sufficient to carry the bracket 304 and perform the scan without the bracket 304 moving.

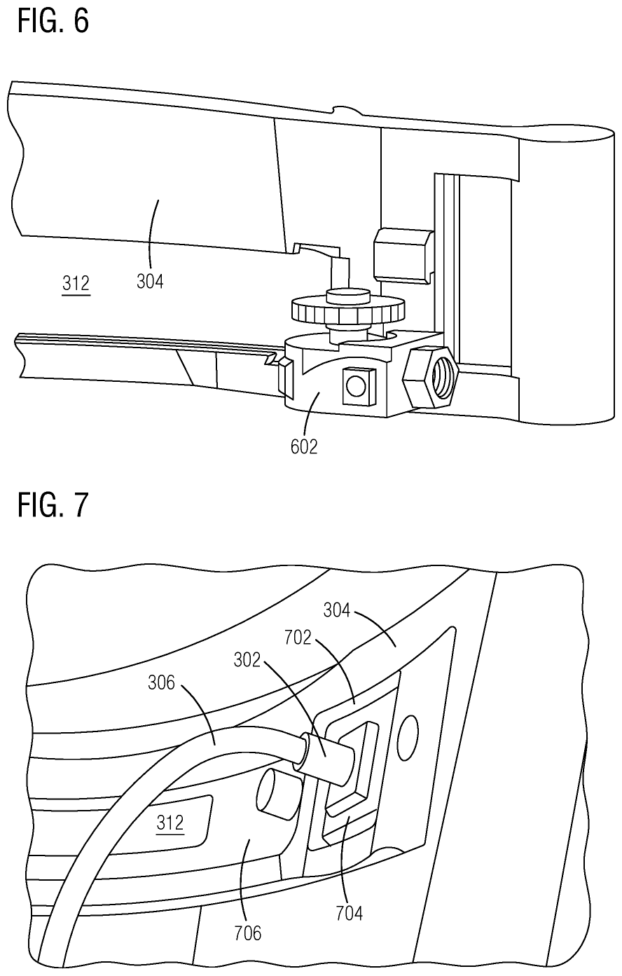

In an embodiment, the bracket 304 includes an encoder 602. FIG. 6 illustrates a partial view of the concave bracket 304 including an encoder 602. The encoder 602 operates with the convex or concave bracket 304 and is attached to the bracket 304 by a fastening device. In the shown embodiment, the encoder 602 is a rotary encoder that tracks the turning of its shaft and generates a digital position of the ultrasonic probe 302 within the slot 312. A generated scan produced with the ultrasonic phased array inspection system 300 having an encoder 602 includes the positional data of the ultrasonic probe 302.

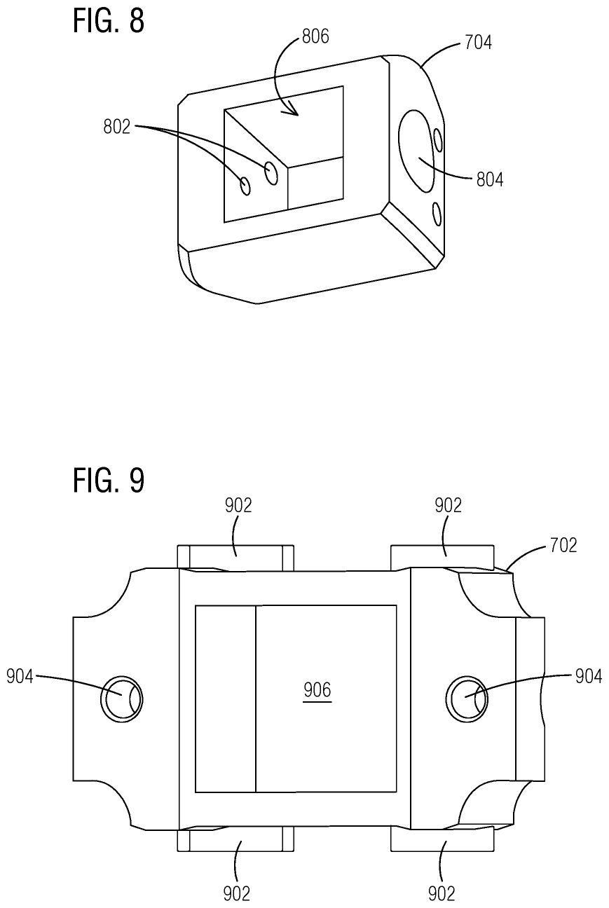

FIG. 7 illustrates a perspective view of a concave bracket 304 with an ultrasonic probe 302 mounted within a sled mechanism. The sled mechanism includes a sled 702 and an insert 704 that may be inserted within the sled 702. In an embodiment, the ultrasonic probe 302 may be mounted within the insert 704 fitted within the sled 702 and attached to a ruler 706 within the slot 312. The insert 704 and sled 702, respectively, are shown in FIG. 8 and FIG. 9.

The sled mechanism is manually moved within the slot 312 of the bracket 304 by pushing or pulling the ruler 706. While the sled 702 may be utilized for positioning the ultrasonic probe 302 within the slot 312, in other embodiments, the ultrasonic probe 302 may be manually positioned without the sled mechanism and moved within the slot 312. For example, with respect to the input and output brackets 304, the ultrasonic probe 302 may be manually positioned within each of the slots 312. However, the sled mechanism provides a more accurate way to position the ultrasonic probe 302 within the slot 312.

FIG. 8 illustrates a perspective view of the insert 704. The shown embodiment of the insert 704 includes a square opening 806 in which the ultrasonic probe 302 is inserted. However, other opening shapes may accommodate the ultrasonic probe 302. The small holes 802 are used to hold the ultrasonic probe 302 within the insert 704. The large hole 804 shown is used to hold a magnet for the purpose of holding the insert 704 within the sled 702.

FIG. 9 illustrates a perspective view of the sled 702. The insert 704 with the mounted ultrasonic probe 302 may then be placed within an opening 906 in the sled 702. The sled 702, as shown in FIG. 9 includes wheels 902 creating a trolley so that the sled 702 may slide within the ruler 706. The sled mechanism is then attached to the ruler 706. The ruler is attached to either end of the sled 702 by a screw. The ruler 706 is used to either push or pull the sled mechanism inside the slot 312 from one of the blade leading edge to the opposite end.

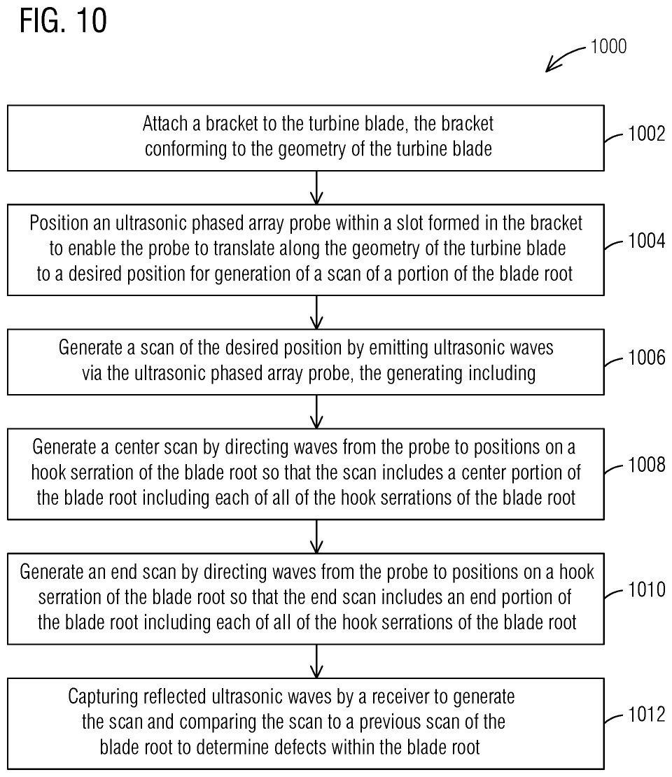

FIG. 10 describes a nondestructive method for a volumetric examination of a blade root 202 of a turbine blade 108 while the turbine blade 108 is installed in a turbine shaft 104 of a steam turbine 100. In a first step 1002, a bracket 304 is attached to the turbine blade 108, the bracket 304 conforming to the geometry of the turbine blade 108. In a second step 1004, an ultrasonic phased array ultrasonic probe 302 is positioned within a slot 312 formed in the bracket 304 to enable the ultrasonic probe 302 to translate along the geometry of the turbine blade 108 to a desired position for generation of a scan of a portion of the blade root 202. In a third step 1006, a scan is generated of the desired position by directing ultrasonic waves via the ultrasonic phased array ultrasonic probe 302, the generating including generating a center scan by directing waves from the ultrasonic probe 302 to positions on a hook serration 206 of the blade root 202 so that the scan includes a center portion of the blade root 202 including each of all of the hook serrations 206 of the blade root 202. In addition, the generating includes generating an end scan by directing waves from the ultrasonic probe 302 to positions on a hook serration 206 of the blade root 202 so that the end scan includes an end portion of the blade root 202 including each of all of the hook serrations 206 of the blade root 202. In fourth step 1012, reflected ultrasonic waves are captured by a receiver 310 to generate the scan and comparing the scan to a previous scan of the blade root 202 to determine defects within the blade root 202.

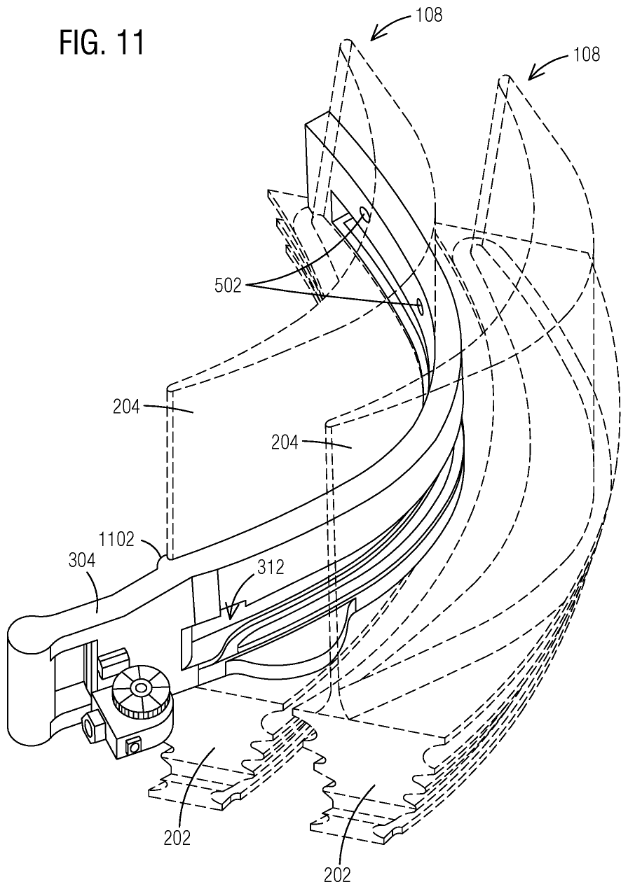

The presented method for volumetric examination of the blade root 202 of turbine blade 108 may be performed while the turbine blade 108 is installed in a turbine shaft 104 of a steam turbine 100. Technical personnel can access the turbine blade 108 while installed in the turbine shaft 104 through a manway door. Thus, disassembly of the turbine blade 108 from the turbine shaft 104 is avoided. The bracket 304 may then be attached to the turbine blade 108, the bracket 304 conforming to the geometry of the turbine blade 108. The bracket 304 can be positioned on the blade airfoil 204 or the blade platform 208 without touching the adjacent blade. FIG. 11 illustrates a perspective view of two adjacent turbine blades 108, their blade roots 202 installed in the turbine shaft 104 (not shown) with a convex bracket 304 installed on the turbine blade 108 shown on the left side of the figure without touching the adjacent turbine blade 108 shown on the right side of the figure. The convex bracket 304 may be held to the turbine blade 108 by magnets inserted in one or more holes 502 formed in the bracket 304. The convex bracket 304 may include a handle 1102, as shown, that attaches over the leading edge of the turbine blade 108 to further conform to the geometry of the turbine blade 108.

The ultrasonic probe 302 is positioned within the slot 312 formed in the bracket 304 to enable the ultrasonic probe 302 to translate along the geometry of the turbine blade 108 to a desired position to generate a scan of a portion of the blade root 202. The ultrasonic probe 302 can be placed at an optimum location to achieve the best detection of defects within the blade root 202 with the least amount of interference with the geometry of the turbine blade 108. Referring to FIG. 11, the convex bracket 304 allows the ultrasonic probe 302 to be positioned so that a scan of a central portion of the pressure side of the turbine blade root 202, i.e., opposite the side the ultrasonic probe 302 is positioned, can be generated. Similarly, the concave bracket attached to the concave, or pressure side, of the blade airfoil 204, allows the ultrasonic probe 302 to be positioned so that a scan of a central portion of the suction side of the blade root 202, i.e., opposite the side the ultrasonic probe 302 is positioned, can be generated. The slots 312 in the inlet and outlet brackets 304 allow the ultrasonic probe 302 to be positioned so that the convex and concave sides of the blade root 202 on each of the inlet side and outlet side, respectively, can be scanned.

In order to generate a scan of a desired position, the ultrasonic probe 302 directs an ultrasonic wave produced from an electrical signal of the source 308. Using an ultrasonic probe 302 constructed as a phased array enables the ultrasonic waves to be directed in different directions. This makes it possible to send out the ultrasonic waves to perform so called angle scans over a relatively large angular range. The ultrasonic waves are directed in an angular range with respect to a main direction of irradiation extending essentially perpendicularly to the surface of the turbine blade 108 at the location of the ultrasonic probe 302.

In an embodiment, the scanning includes scanning all hook serrations 206 for an examination. The blade root 202 may include 3-4 hook serrations 206. The embodiment of the blade root 202 having four hook serrations 206 includes a different geometry than the blade root geometry having three hook serrations 206. For example, the radius of the hook serration 206 for the four hook fir tree blade root design may be smaller such that the curvature is sharper at some points than the curvature of the three hook fir tree blade root design. Because of this sharp curvature, defects may be harder to see in the generated echo scan. In an embodiment, the ultrasonic waves generated from the ultrasonic probe 302 are shear waves in an angular range of 30-85 degrees with respect to the main direction of irradiation. In another embodiment, the ultrasonic waves generated from the ultrasonic probe 302 are compression waves in an angular range of −45 degrees to 45 degrees.

As an example, in order to increase the scanning coverage of the blade root 202, on the inlet and outlet sides, three slots 312 (see FIG. 4) formed in each of the inlet and outlet brackets 304 may be used. The two outer slots 312 are used to position the ultrasonic probe 302 at positions to generate scans of all the hook serrations 206, especially the hook serration 206 (Hook 4) furthest from the platform 208, on the same side of the blade root 202 as the ultrasonic probe 302 is positioned. Compression waves may be used for increased coverage of the hook serrations 206 furthest away from the platform 208 because the geometry of the blade root 202 in some areas can only be scanned using a specific ultrasonic probe 302 position and a specific beam angle.

In order to detect defects in the turbine blade root 202, the generated scans may be compared to reference scans of defect-free blade roots by evaluating differences between the generated scan and the reference scan.

In summary, Applicant provides an ultrasonic phased array inspection system including a bracket conforming to the geometry of a turbine blade and an ultrasonic phased array system. The ultrasonic phased array inspection system may be used to position and guide an ultrasonic array probe for a better detection of flaws and more coverage of the blade root than has been traditionally done. The ultrasonic phased array inspection system is capable of performing the inspection with the turbine rotor in place through a manway door and avoiding disassembly of the steam turbine.

What is claimed is:

1. A system for a volumetric examination of a blade root of a turbine blade, comprising:
an ultrasonic phased array probe;
a bracket defining a slot, the bracket carried by and conforming to the geometry of the turbine blade,
wherein the probe is positioned within the slot to guide the probe to a desired position for generation of a scan of a portion of the blade root,
wherein the bracket includes a first slot on a suction side and a second slot on a pressure side, the probe positionable within the first slot or the second slot to direct a wave in a direction to allow for scanning a position on a hook serration of the blade root;
an ultrasonic signal source connected to the probe via a line that provides an ultrasonic pulse signal; and
a receiver connected to the probe via the line for receiving reflected ultrasonic pulse signals,
wherein the scan is generated from the reflected ultrasonic pulse signals,
wherein the hook serration includes all the hook serrations of the blade root, and
wherein the examination includes a scan of at least one of the pressure side of the blade root, the suction side of the blade root, and all the hook serrations of the blade root.

2. The system of claim 1, further comprising an encoder attached to the bracket that gives a position of the probe within the slot and wherein the scan includes positional data of the probe.

3. The system of claim 1, wherein the bracket further defines a hole, and wherein a magnet is positioned within the hole to attach the bracket to the turbine blade.

4. The system of claim 1, wherein the blade root includes four fir tree hook serrations.

5. The system of claim 1, wherein the phased array probe emits compression waves.

6. The system of claim 1, wherein the phased array probe emits shear waves.

7. The system of claim 1, wherein the bracket includes each of a convex bracket conforming to the suction side of the turbine blade, a concave bracket conforming to the pressure side of the turbine blade, an inlet bracket conforming to an inlet side of the turbine blade, and an outlet bracket conforming to the geometry of the outlet side of the turbine blade.

8. The system of claim 1, wherein the inlet bracket and the outlet bracket each includes a further slot defined within the bracket and sized to allow for scanning the hook serration of an inlet portion or an outlet portion, respectfully, of the blade root.

9. A nondestructive method for a volumetric examination of a blade root of a turbine blade while the turbine blade is installed in a turbine shaft of a steam turbine, the method comprising:
attaching a bracket to the turbine blade, the bracket conforming to the geometry of the turbine blade;
positioning an ultrasonic phased array probe within a slot formed in the bracket to enable the probe to translate along the geometry of the turbine blade to a desired position for generation of a scan of a portion of the blade root,
generating a scan of the desired position by directing ultrasonic waves via the ultrasonic phased array probe, the generating including:
generating a center scan by directing waves from the probe to positions on a hook serration of the blade root so that the scan includes a center portion of the blade root including each of all of the hook serrations of the blade root, and
generating an end scan by directing waves from the probe to positions on a hook serration of the blade root so that the end scan includes an end portion of the blade root including each of all of the hook serrations of the blade root;
capturing reflected ultrasonic waves by a receiver to generate the scan and comparing the scan to a reference scan of the blade root to determine defects within the blade root.

10. The nondestructive method of claim 9, further comprising attaching the bracket to the turbine blade using a magnet positioned within a hole formed in the bracket.

11. The nondestructive method of claim 9, wherein the bracket is attached to the turbine blade installed in the turbine shaft without touching an adjacent turbine blade installed on the turbine shaft.

12. The nondestructive method of claim 9, wherein the ultrasonic waves emitted are shear waves.

13. The nondestructive method of claim 12, wherein the ultrasonic waves are emitted in an angular range between 30 degrees to 85 degrees with respect to a main direction of irradiation.

14. The nondestructive method of claim 9, wherein the ultrasonic waves emitted are compression waves.

15. The nondestructive method of claim 14, wherein the ultrasonic waves are emitted in an angular range between −45 degrees to 45 degrees with respect to a main direction of irradiation.

16. The nondestructive method of claim 14, wherein the positioning includes coupling the phased array probe to a sled disposed within a slot formed in the bracket and operating the sled to move the probe within the slot to translate the probe along the geometry of the turbine blade.

17. The nondestructive method of claim 16, further comprising an encoder to determine a position of the probe as it moves within the slot, wherein the captured reflected ultrasonic waves include the position.

18. The nondestructive method of claim 16, further comprising:
removing a manway door to gain access to the turbine blade installed in the turbine rotor of the steam turbine.
